(19) United States
(12) Patent Application Publication
(10) Pub. No.: US 2006/0123267 A1
(43) Pub. Date: Jun. 8, 2006

(54) Monitoring the state of a communications network

(76) Inventors: Robert Weeks, Warwickshire (GB); Ian John Ormshaw, Warrington (GB); Neil Brotherton, Coventry (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/513,501

(22) PCT Filed: Apr. 29, 2003
(86) PCT No.: PCT/GB03/01835

§ 371 Date: Aug. 12, 2005

(30) Foreign Application Priority Data
May 7, 2002 (GB) 0210298.6

(51) Int. Cl. G06F 11/00

(52) U.S. Cl. 714/4

(57) ABSTRACT

An interface element is adapted to interface with a communications network and includes a monitor to monitor the state of the network, and a method of using the interface element. The monitor may monitor the state of the network by monitoring the state of a link or component of the network, by receiving one or more messages regarding the state of the link/component. The monitor may monitor the state of the network by registering any changes in the state of the network or by registering any faults occurring in the network. The monitor may communicate the state of the network to one or more components of the network. The interface element may react to the state/changes in the state of the network. The monitor may comprise a router, running routing protocol software with which the network can communicate, e.g., the Open Shortest Path First routing protocol. The interface element may comprise a host, such as a residential gateway programmable device. The communications network may be a packet-switched internet protocol based network and may carry telephony-type information and data information.

This invention relates to monitoring the state of a communications network, and particularly monitoring changes in the state of a network, for example due to faults occurring in the network, both locally to an interface element of the network and farther into the network.

Communications networks having numerous topologies exist. As such networks become larger and more complex, it is often desirable to monitor the state of a network and particularly any changes therein. For example, if a fault should occur on any link in a network, it is desirable that this change in the network state should be detected rapidly such that, for example, appropriate action can be taken.

Monitoring and being able to react to changes in the state of a network are particularly important when packet-switched communications networks are used to carry telephony-type information, e.g. voice or video information. Traditionally, such information has been carried by circuit-switched communications networks, i.e. networks where effectively a dedicated connection is established between a sender and a receiver of the information. With the advent of more and more data applications, communications networks have been developed to carry data information, e.g. data files, e mails, etc. Such networks include packet-switched networks, i.e. networks in which information to be carried is split up into packets, which may take different routes across a network from a sender to a receiver. This way of carrying information offers various advantages, e.g. the ability to more easily accommodate additional users, and such networks are now being used for carrying telephony-type information. When information is carried in packets, it is possible that one or more packets may be delayed or lost, e.g. due to a fault occurring in the communications network. This is not so critical for data information, where delayed packets can be reintroduced into the data stream in the correct place and lost packets can be retransmitted. However, for telephony-type information, delays exceeding a few milliseconds and retransmission are undesirable if, for example, a call in progress is not to be interrupted, and an acceptable grade of service, e.g. a ‘Five Nines’ telco-grade, is to be provided. To use communications networks such as packet-switched networks for carrying telephony-type information, it is desirable that any changes in the state of any part of the network, e.g. due to faults, be monitored preferably rapidly, so that action, e.g. rerouting, can be taken without undue delay or loss of information. It is desirable that components of a network and elements which interface with the network are capable of monitoring or are informed of the state of the network, to allow them to compensate for any changes therein.

Systems for monitoring the state of a communications network are known. For example, the state can be monitored by means of timeouts between components of the network or between elements which interface with the network. However, these by their very nature take time to expire providing a slow detection of faults and increasing the possibility of unacceptable delays or loss of information. Faster detection of faults can be achieved by providing intelligent monitoring devices within the network. However this approach suffers from the addition of, often expensive, equipment to the network, which requires access to and modification of the network, and provides an additional possible source of faults within the network.

According to a first aspect of the present invention there is provided an interface element adapted to interface with a communications network, the element comprising monitor means to monitor the state of the network.

According to a second aspect of the present invention there is provided a method of using an interface element according to the first aspect of the invention to monitor the state of a communications network.

The monitor means may monitor the state of the network by receiving one or more messages regarding the state of at least one link of the network. The or each message may comprise information regarding the ability of the link to carry information. The or each message may be received from one or more link-state monitors of the interface element. The or each message may be received from one or more components of the network. The link may comprise, for example, a peripheral link of the network, which may connect the network and the interface element.

The monitor means may monitor the state of the network by receiving one or more messages regarding the state of at least one component of the network. The or each message may comprise information regarding the ability of the component to carry information. The or each message may be received from the component.

The monitor means may monitor the state of the network by receiving one or more massages regarding one or more connection paths available to one or more components of the network. The or each message may comprise information regarding connection paths between, for example, the or each component and one or more other components of the network and/or one or more elements which interface with the network. The or each message may comprise information regarding a measure of the cost of using the or each connection path. The or each message may be received from the one or more

The monitor means may monitor the state of the network by registering any changes in the state of the network, for example changes in the state of at least one link or component of the network. The monitor means may register any changes in the ability of a link or component of the network to carry information. A change in the state of the network may be caused by a fault occurring in the network. The monitor means may monitor the state of the network by registering any faults occurring in the network, for example faults occurring in a link or a component of the network.

The monitor means may communicate with one or more components of the network. For example, the monitor means may communicate the state of the network and/or changes in the state of the network to the one or more components of the network. This may comprise communicating one or more messages regarding the state of at least one link and/or at least one component of the network to the one or more components of the network. Communicating with the one or more components may allow the network to compensate for any changes occurring in the state of the network. The monitor means may communicate the state of the interface element and/or changes in the state of the interface element to one or more components of the network.

Monitoring the state of the network may allow the interface element to react to the state of the network. Monitoring any changes in the state of the network, e.g. due to a fault, may allow the interface element to compensate for a change in the state. The interface element and the network are therefore said to be more resilient. The interface element may compensate for a change in the state of the network by causing information sent by it to the network to be rerouted. Because the monitor means actively registers state changes and does not rely on timeouts, the rerouting can take place very quickly. Rerouting of the information preferably takes place in sub-second times. The network can therefore more easily provide a required level of service for handling telephony-type information. The monitor means may provide a routing function.

By providing the interface element with the means to monitor the state of the network, this avoids providing additional components to the network or modification of existing components of the network to carry out this function. This reduces the expense involved in developing the network, access required to the network, and avoids adding additional possible sources of faults within the network.

The monitor means may be implemented on one or more microprocessors, which may be added to the interface element. The monitor means may be implemented on one or more existing microprocessors of the interface element. The monitor means may comprise a router. The router may comprise one or more microprocessors which are added to the interface element, or which are existing microprocessors of the interface element. The router may comprise one or more microprocessors running routing protocol software. The routing protocol software preferably comprises routing protocol software with which one or more components of the network can communicate. This will allow information on the state of the network and/or the state of the interface element to be communicated between the router and the network. The routing protocol software preferably comprises a standard protocol implemented on one or more components of the network, e.g. the Open Shortest Path First (OSPF) routing protocol. Using a standard routing protocol allows the monitor means to be readily used with a network which can communicate with this protocol. The monitor means preferably connects the interface element to the communications network. The monitor means may comprise two or more connections to the communications network.

The interface element may comprise a host, for example a telephone or a personal computer, or a media gateway programmable device or a residential gateway programmable device. The interface element may run application software, used in the operation of the element. The application software is preferably implemented in the interface element separately from any routing protocol software of the monitor means. The interface element may comprise one or more microprocessors running application software. The interface element may comprise one or more microprocessors running communications stack software. The interface element may comprise one or more link-state monitors. The or each link-state monitor may be connected between the monitor means and the communications network.

The communications network is preferably a packet-switched network. The communications network may be an internet protocol (IP) based network operating over a link-layer protocol, e.g. an Ethernet network or a Packet over SONET/SDH network or a Packet over ATM AAL5 network or a Packet over ATM AAL2 network. The communications network may carry telephony-type information, e.g. voice or video information, and/or data information, e.g. data files or e mail.

An embodiment of the invention will now be described by way of example only, with reference to the accompanying drawings in which:

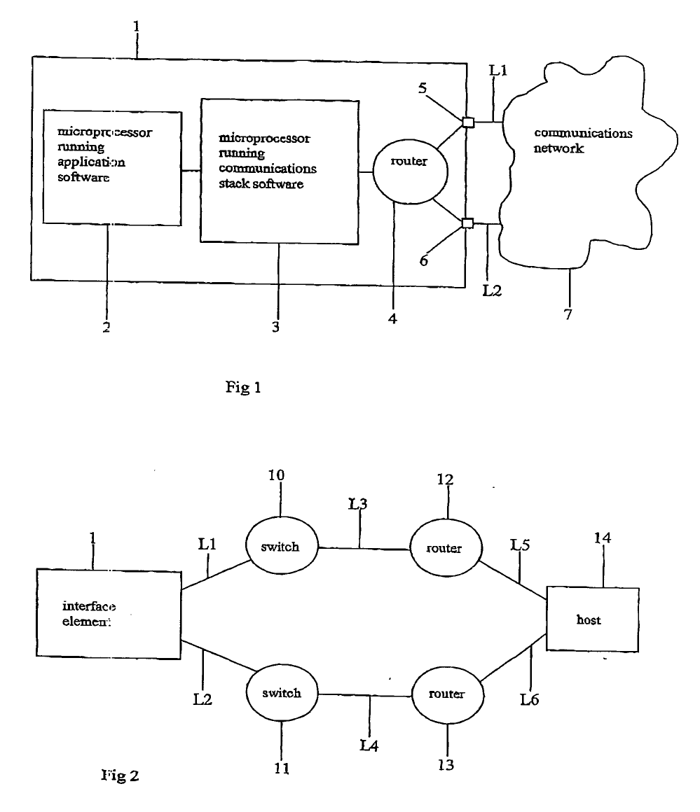

FIG. 1 is a schematic representation of an interface element according to the first aspect of the invention, and

FIG. 2 is a schematic representation of a communications network connected to the interface element of FIG. 1.

Referring to FIG. 1, the interface element 1 comprises a microprocessor 2 running application software, a microprocessor 3 running communications stack software, monitor means comprising a router 4 and link-state monitors 5 and 6. The interface element is connected to a number of telephones (not shown). The microprocessor 2 is connected to the microprocessor 3, which is connected to the router 4, which in turn is connected to the link-state monitors 5, 6, as shown. The link-state monitor 5 is connected to link L1 of a communications network 7, and the link-state monitor 6 is connected to link L2 of the communications network 7. The network is a packet-switched network using the OSPF routing protocol. The application software running on microprocessor 2 enables the interface element to receive information from the telephones and to packetise the information. The information packets are then passed to the microprocessor 3 running the communications stack software which decides on the way in which the packets are to be sent to the communications network 7. The packets are forwarded to the router 4 and from there to the link-state monitors 5, 6 for onward transmission to the network 7 via link L1 and/or link L2. In a similar fashion, information packets from the network 7 are received by the link-state monitors 5, 6 via link L1 and/or link L2, and are transmitted to the router 4, the microprocessor 3, and onwards to the microprocessor 2 where the packets are reassembled and the information transmitted to the telephones as appropriate. In addition to carrying information packets to and from the interface element, the links L1 and L2, when operating normally, also send a background pulsed signal to the link-state monitors 5, 6. On receipt of this signal each monitor sends messages to the router 4 indicating that the links are able to carry information.

The router 4 comprises a microprocessor which runs the OSPF routing protocol. The router microprocessor monitors the state of the network 7, by receiving messages regarding the state of the links L1 and L2 from the link-state monitors 5, 6, and by receiving messages regarding the state of the components of the network and regarding the connection paths available to the components via the links L1 and L2. The router microprocessor also sends messages regarding the state of the network and the state of the interlace element to the network components, so that they may compensate for any changes therein.

FIG. 2 illustrates a communications network connected to the interface element 1 of FIG. 1. The network comprises a first switch 10, a second switch 11, a first router 12 and a second router 13. The first switch 10 is connected to the interface element via the link L1, and the second switch 11 is connected to the interface element via the link L2. The first switch 10 is connected to the first router 12 via a link L3, and the second switch 11 is connected to the second router 13 via a link L4. The first router 12 is connected to a host 14 via a link L5, and the second router 13 is connected to the host 14 via a link L6. In normal operation information packets from the interface element 1 are sent to the host 14 via link L1, first switch 10, link L3, first router 12 and link L5 and/or via link L2, second switch 11, link L4, second router 13 and link L6. However, circumstances may occur in which, for example, link L1 becomes unable to carry information packets, for example a fault may occur on this link. In such a case, the link-state monitor 5 sends a message to the router 4 indicating that the link L1 cannot carry information, and the router 4 reroutes all the information packets via link L2. The router 4 also communicates the change in the state of link L1 to the components of the network via link L2. This allows the network to reroute all the information for the interface element 1 via link L2. This is an important function of the router 4 as generally the switches 10, 11 are relatively dumb and cannot communicate such a state change to the other components of the network, to allow such rerouting.

1-38. (canceled)

39: An interface element for interfacing with a communications network having network elements interconnected with communication links, the interface element comprising: monitor means for monitoring a state of at least two of the communication links coupled to the interface element; and, dependent on the monitored state of at least one of the communication links, the monitor means is operative for informing other network elements of the communication network of changes detected by the monitor means in the monitored state of at least one of the communication links over another of-the communication links coupled to the interface element.

40: The interface element according to claim 39, in which the monitor means monitors a state of the network by receiving at least one message regarding the state of at least one of the communication links of the network.

41: The interface element according to claim 40, in which the at least one message comprises information regarding an ability of the at least one communication link to carry information.

42: The interface element according to claim 40, in which the at least one message is received from at least one link-state monitor of the interface element.

43: The interface element according to claim 40, in which the at least one message is received from at least one component of the network.

44: The interface element according to claim 40, in which the at least one communication link comprises a peripheral link of the network, the peripheral link connecting the network and the interface element.

45: The interface element according to claim 39, in which the monitor means monitors a state of the network by receiving at least one message regarding a state of at least one component of the network.

46: The interface element according to claim 45, in which the at least one message comprises information regarding an ability of the at least one component to carry information.

47: The interface element according to claim 45, in which the at least one message is received from the at least one component.

48: The interface element according to claim 39, in which the monitor means monitors a state of the network by receiving at least one message regarding at least one connection path available to at least one component of the network.

49: The interface element according to claim 48, in which the at least one message comprises information regarding connection paths between the at least one component and at least one other component of the network and at least one element which interfaces with the network.

50: The interface element according to claim 48, in which the at least one message comprises information regarding a measure of a cost of using the at least one connection path.

51: The interface element according to claim 48, in which the at least one message is received from the at least one component of the network.

52: The interface element according to claim 39, in which the monitor means monitors a state of the network by registering any changes in the state of the network.

53: The interface element according to claim 52, in which the monitor means monitors the state of the network by registering any changes in the state of at least one of the communication links and at least one component of the network.

54: The interface element according to claim 39, in which the monitor means monitors a state of the network by registering any faults occurring in the network.

55: The interface element according to claim 39, in which the monitor means communicates with at least one component of the network.

56: The interface element according to claim 55, in which the monitor means communicates a state of the network to the at least one component of the network.

57: The interface element according to claim 39, in which the monitor means communicates a state of the interface element to at least one component of the network.

58: The interface element according to claim 39, in which the monitor means is operative for monitoring a state of the network and allows the interface element to react to the state of the network.

59: The interface element according to claim 39, in which the monitor means is operative for monitoring any changes in a state of the network and allows the interface element to compensate for a change in the state of the network.

60: The interface element according to claim 59, in which the monitor means is operative for compensating for a change in the state of the network by causing information sent by it to the network to be rerouted.

61: The interface element according to claim 60, in which rerouting of the information takes place in sub-second times.

62: The interface element according to claim 60, in which the monitor means provides a routing function.

63: The interface element according to claim 39, in which the monitor means is implemented on at least one microprocessor added to the interface element.

64: The interface element according to claim 39, in which the monitor means is implemented on at least one existing microprocessor of the interface element.

65: The interface element according to claim 39, in which the monitor means comprises a router.

66: The interface element according to claim 65, in which the router comprises at least one microprocessor running routing protocol software.

67: The interface element according to claim 66, in which the routing protocol software comprises routing protocol software with which at least one component of the network communicates.

68: The interface element according to claim 66, in which the routing protocol software comprises the Open Shortest Path First (OSPF) routing protocol.

69: The interface element according to claim 39, in which the monitor means connects the interface element to the communications network.

70: The interface element according to claim 69, in which the monitor means comprises at least two connections to the communications network.

71: The interface element according to claim 39, in which the interface element comprises a host.

72: The interface element according to claim 71, in which the host is one of a media and a residential gateway programmable device.

73: The interface element according to claim 39, in the communications network is a packet-switched network.

74: The interface element according to claim 73, in which the packet-switched network is an internet protocol (IP) based network operating over a link-layer protocol.

75: The interface element according to claim 39, in which the communications network carries telephony-type information and data information.

76: A method of using an interface element to monitor a state of a communications network having network elements interconnected with communication links, comprising the steps of: monitoring a state of at least two of the communication links coupled to the interface element; and, dependent on the monitored state of at least one of the communication links, informing other network elements of the communication network of changes detected in the monitored state of at least one of the communication links over another of the communication links coupled to the interface element.
